(19) United States
(12) Patent Application Publication
(10) Pub. No.: US 2007/0170721 A1
(43) Pub. Date: Jul. 26, 2007

(54) Interlocking coupling

(75) Inventor: Chris M. Cook, Mckenzie, TN (US)

Correspondence Address: MARSHALL & MELHORN, LLC, FOUR SEAGATE, 8TH FLOOR, TOLEDO, OH, 43804, US

(73) Assignee: DANA CORPORATION

(21) Appl. No.: 11/339,942

(22) Filed: Jan. 26, 2006

(51) Int. Cl. F16L 33/00

(52) U.S. Cl. 285/256

(57) ABSTRACT

A coupling for connecting conduits is provided, including a first element having a first mating member and a second element having a second mating member. The first element and the second element selectively securingly engaging each other. The first mating member and the second mating member sealingly connecting the conduits. An inner member is disposed at least partially within the second element, and a compression member is disposed about the first element, the compression member cooperating with the inner member for forcing the first element and the second element together, wherein the first element, the second element, and the inner member cooperate to resist pulling apart of the coupling.

### TECHNICAL FIELD

The embodiments described herein are generally directed to joining and sealing conduits.

### BACKGROUND

Typical hose or conduit connections require an intermediate fitting and a clamp on both sides of the fitting to secure the connection. The outer surface of the intermediate fitting has circumferential barbs to augment axial connection strength. The clamp compresses the hose against the barbs making it more difficult to pull the hose from the intermediate fitting. A typical arrangement includes a double barb design on either end of the intermediate fitting. A hose clamp for each barb design then secures the hoses together.

However, the double barb design does not provide a highly reliable connection when axial force is applied. Because the hose is compressed against the radial barbs, an expansion of the hose or infiltration of materials may cause a reduced coefficient of friction between the hose and the barbs. Thus, the magnitude of the axial force required to pull the hose from the intermediate fitting is reduced. Further, the current design requires two hose clamps that necessarily lead to increased cost of parts and assembly time while at the same time reducing reliability.

Therefore, a need exists for a stronger port connection that resists being pulled apart. Further, it is desirable that the port connection have increased reliability as well as reduced cost of parts.

### SUMMARY

A coupling for connecting conduits is provided, including a first element having a first mating member and a second element having a second mating member. The first element and the second element selectively securingly engaging each other. The first mating member and the second mating member sealingly connecting the conduits. An inner member is disposed at least partially within the second element, and a compression member is disposed about the first element, the compression member cooperating with the inner member for forcing the first element and the second element together, wherein the first element, the second element, and the inner member cooperate to resist pulling apart of the coupling.

### BRIEF DESCRIPTION OF THE DRAWINGS

The features and inventive aspects of the present invention will become more apparent upon reading the following detailed description, claims, and drawings, of which the following is a brief description:

FIG. 1 is a partial axial sectional view of an embodiment of an interlock port of the present invention;

FIG. 2 is a partial axial sectional of a first element of the embodiment of FIG. 1;

FIG. 3 is a partial axial sectional view of a second element of the embodiment of FIG. 1;

FIG. 4 is a partial axial sectional view of an inner member of the embodiment of FIG. 1; and

FIG. 5 is a partial cross-sectional view of the inner member of FIG. 4 taken along line 5-5 of FIG. 4.

### DETAILED DESCRIPTION

Referring now to the drawings, an illustrative embodiment is shown in detail. The drawings are not necessarily to scale and certain features may be exaggerated to better illustrate and explain an innovative aspect of an embodiment. Further, the embodiment described herein is not intended to be exhaustive or otherwise limit or restrict the invention to the precise form and configuration shown in the drawings and disclosed in the following detailed description.

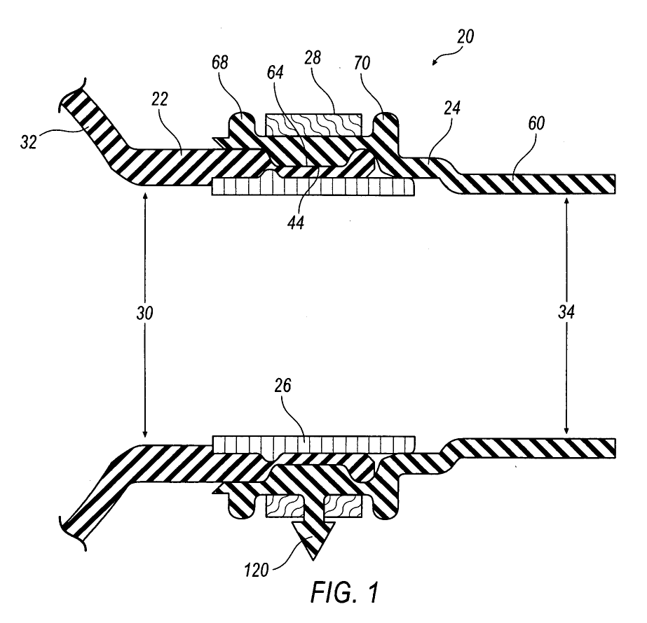

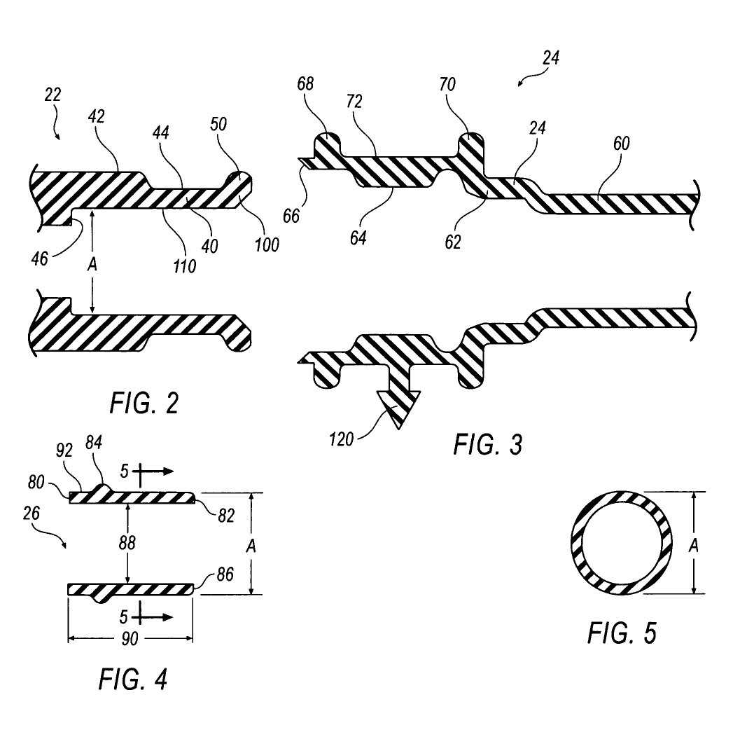

FIGS. 1-5 illustrate an interlock port 20 having a first element 22, a second element 24, an inner member 26 and a compression member 28. In the present embodiment, first element 22 provides a port opening 30 for an air duct 32. However, first element 22 may provide a port for fluids other than air. Interlock port 20 is typically used to connect two conduits for routing fluid products, including liquids and gases. However, interlock port 20 is not limited to such an application. Interlock port 20 could also be employed for blowing solid materials. Second element 24 defines a lumen 34 for fluid (e.g., in this embodiment the fluid is air) to pass through.

First element 22, in this embodiment configured as the male connector, includes a first mating member 40, a first outer surface 42, a groove 44, a notch 46, a slot 48, and a locking end 50. Second element 24, in this embodiment configured as a female connector, includes a hose 60, a second mating member 62, a tongue 64, a lead-in 66, a first guide 68, a second guide 70, a second outer surface 72, and a bump-out 74. Further, first element 22 is made of a rubber material, or rubber-like material.

Inner member 26 includes a first end 80, a second end 82, a barb 84, and a round over-element 86. Round over-element 86 facilitates assembly by providing an angled surface for lead-in 66 to pass by when second element 24 is pushed onto first element 22. Inner member 26 is constructed of a rigid plastic material.

Inner member 26 is positioned within first element 22 and provides a surface for compression member 28 to press first element 22 and second element 24 against. The thickness of inner member 26 is configured to fit within first element 22 and interfere with notch 46 when assembled. An inner diameter 88 is chosen to avoid restriction of flow through interlock port 20. A length 90 is configured to at least provide a surface under compression member 28 when between guides 68, 70. Additionally, inner member 26 is configured of a material and in structure such that the shape is retained when placed under pressure from compression member 28. Otherwise, if inner member 26 were to collapse under pressure, interlock port 20 would not effectively seal or hold first element 22 and second element 24.

FIG. 1 illustrates in detail the assembly of interlock port 20. Compression member 28 is loosely placed around second element 24 and between first guide 68 and second guide 70 to allow for further preparation of the components. When compression member 28 is affixed and tensioned, the force is applied over second element 24, first element 22, and inner member 26. Further, because guides 68, 70 are circumferentially located about second element 24, the alignment of compression member 28 is perpendicular to the axis of second element 24.

Inner member 26 is pushed within port opening 30 of first element 22 and is prevented from traveling farther than notch 46 by the interference of notch 46 with first end 80. Barb 84 is provided on an outer surface 92 of inner member 26 to retain inner member 26 during assembly. Barb 84 interferes with a smooth inner surface 110 of first element 22 and creates a seal therebetween. An inner member lead-in 100 is provided on first element 22 such that first end 80 of inner member 26 is centered within first element 22 for ease of assembly.

With inner member 26 in place, first element 22 and second element 24 are pressed together until tongue 64 of second mating member 62 is seated within groove 44 of first mating member 40. The connection of tongue 64 and groove 44 provide the initial holding force allowing for final assembly. Guides 68, 70 hold compression member in place around second element 24 such that the compression force is properly located around second element 24, first element 22, and inner member 26 when assembled. The alignment provides for the compression force to act upon tongue 64 and groove 44 that are located between compression member 28 and inner member 26. To complete installation, compression member 28 is employed from a loose state to a compression state such that force is applied to tongue 64 and groove 44.

Second element 24 may also include a tab 120 for locating compression member 28 along the periphery of second element 24. In this case, compression member 28 includes a hole to receive tab 120. During assembly, tab 120 locates compression member 28 such that a typical hose clamp screw head compression mechanism (not shown) may be employed. The location of the screw head mechanism becomes important at least because of access limitations or ease of installation issues. Bump-out 74 allows for the flexibility of sizing for length 90 of inner member 26 and facilitates manufacturing by allowing greater tolerances. Further, along with tongue 64 and groove 44, bump-out 74 also assists in preventing second element 24 from being pressed beyond the desired depth over first element 22.

In use, interlock port 20 is held in place by the forces between tongue 64 and groove 44 as applied by the forces between compression member 28 and inner member 26. Tongue 64 and groove 44 resist the pulling apart and the further pressing together of first element 22 and second element 24. Additionally, when under compression, bump 84 is pressed in the softer material of first element 22 and resists pulling apart. Thus, axial connection strength is increased. If force is applied to first element 22 or second element 24 in either any direction, connection is maintained because tongue 64 will be forced against locking end 50 or first element 22. Compression member 28 will further ensure that tongue 64 will not be freed from groove 44 by preventing second element 24 from expanding around locking end 50. Further, while interlock port 20 is engaged, the port connection is sealed by tongue 64 and groove 44. The force applied by compression member 28, as well as the geometry of tongue 64 and groove 44, will determine the sealing pressure of interlock port 20.

Thus, interlock port 20 provides that tongue 64 and groove 44 interlock to join first element 22 and second element 24 together with improved strength and sealing, and improved resistance to being pulled apart. Further, cost is reduced because interlock port 20 requires only a single compression member 28 (a hose clamp in this embodiment).

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A coupling for connecting conduits comprising:
a first element having a first mating member;
a second element having a second mating member, said first element and said second element selectively securingly engaging each other, said first mating member and said second mating member sealingly connecting the conduits;
an inner member disposed at least partially within said second element; and
a compression member disposed about said first element, said compression member cooperating with said inner member for forcing said first element and said second element together, wherein said first element, said second element, and said inner member cooperate to resist pulling apart of the coupling.

2. The coupling of claim 1, wherein said first element further includes a notch on an inner surface of said first element, said inner member selectively aligning with said notch.

3. The coupling of claim 1, further comprising:
a tab extending from an outside surface of said second element for aligning said compression member with said second element.

4. The coupling of claim 1, further comprising:
at least one guide disposed on an outer surface of said second element, wherein said at least one guide aligns said compression member with said second element.

5. The coupling of claim 4, wherein said at least one guide further aligns said compression member axially with said first and second mating member when said first and second element are lockingly engaged.

6. The coupling of claim 1, wherein said first and second mating members are configured as a tongue and a groove.

7. The coupling of claim 1, wherein said first and second mating members are configured with differences in radial thicknesses of said first and second elements.

8. A coupling for connecting conduits comprising:
a first element having a first sealing member;
a second element having a second sealing member, said first and second sealing members selectively engaging to sealingly and lockingly engage one another;
a compression member disposed around said first and second sealing members, said compression member forcing said first and second sealing members together; and
an inner member disposed at least partially within said first element, said inner member and said compression member being configured for forcing said first and second sealing members together,
wherein said locking engagement resists disconnection of said first element and said second element once said first sealing member and said second sealing member are engaged.

9. The coupling of claim 8, wherein said inner member is configured to resist compressive force.

10. The coupling of claim 8, wherein said first and second sealing members are configured to resist the pulling apart of said first and second elements.

11. The coupling of claim 8, wherein said first and second sealing members are configured to resist axial pulling apart of said first and second elements.

12. The coupling of claim 8, wherein said first and second sealing members are configured as a tongue and a groove.

13. The coupling of claim 8, wherein said first and second sealing members are configured with differences in radial thicknesses of said first and second elements.

14. The coupling of claim 8, wherein said inner member further includes a generally circumferential bump for sealingly and lockingly engaging said first member.

15. A coupling for connecting conduits comprising:
a first element having a first inner surface and a first outer surface, said first outer surface having a groove;
a second element having a second inner surface and a second outer surface, said second inner surface having a tongue;
an inner member at least partially surrounded by said first inner surface; and
a compression member around said second outer surface, said compression member being aligned with at least a element of said tongue and said inner member, wherein said groove and tongue lockingly engage one another and seal the conduits.

16. The coupling of claim 15, further comprising:
at least one guide disposed upon said second outer surface, whereby said at least one guide aligns said compression member with said second outer surface.

17. The coupling of claim 15, said first element further including an alignment element disposed upon said first inner surface for aligning said inner member with said first element.

18. The coupling of claim 15, wherein said tongue and said groove are configured to resist axial separation of said first and second elements.

19. The coupling of claim 15, wherein said compression member is a hose clamp.

20. The coupling of claim 15, wherein said first and second elements are generally cylindrical.
